(19) United States
(12) Patent Application Publication
(10) Pub. No.: US 2022/0122438 A1
(43) Pub. Date: Apr. 21, 2022

(54) Active Shooter Shield System

(71) Applicant: David J. Miller, Jupiter, TX (US)

(72) Inventor: David J. Miller, Jupiter, TX (US)

(21) Appl. No.: 16/158,300

(22) Filed: Oct. 12, 2018

(51) Int. Cl. G08B 21/02; G08B 25/10; G06Q 50/26

(52) U.S. Cl. CPC G08B 21/02; G06F 3/0482; G06Q 50/265; G08B 25/10

(57) ABSTRACT

This current invention is a system and app that is an Active Shooter Shield application. It is a technological process that, when put in motion, create a real-time active shoot or incident “shield.” This invention essentially provides a way for parties to obtain location specific real-time information at the place of such “incident” and to communicate this information in a very structured manner for those tasked with ending the active incident, preparing for and addressing the injuries and saving lives.

### CROSS-REFERENCES TO RELATED APPLICATIONS (IF ANY)

None

### FEDERALLY SPONSORED OR GOV PROJECT

None

### BACKGROUND

### 1. Field of the Invention

The current invention is a system and application that provides key insight into the technological processes that create solutions that are geared towards limiting the injuries and deaths associated with active and “mass” shooting incidents.

### 2. Description of Prior Art

Sadly over the past decade active shooter incidents have sharply risen in the United States and unfortunately there is no end in sight. Countless lives continue to be lost in both schools and workplaces as a result of these tragic incidents. Unfortunately politicians and society as a whole have yet to come up with a solution that could help prevent or even limit the amount of injuries or deaths that are associated with such incidents.

Active shooter or active terrorism incidents have unfortunately increased in schools and workplaces all over the country. As a result they have fueled a fear within society like we've never seen before. State and Local Government officials, Parents and employers alike are scrambling to find a solution that will limit such disasters and to limit the injuries and deaths associated with these horrific incidents.

There is still room for improvement in the art.

### SUMMARY OF THE INVENTION

This current invention is a system and application (app) that is geared towards limiting the damages of future incidents by creating technological processes that, when put in motion, create a real-time active shoot or incident “shield.” This invention essentially provides a way for parties to obtain location specific real-time information at the place of such “incident” and to communicate this information in a very structured manner for those tasked with ending the active incident, preparing for and addressing the injuries and saving lives. While this invention is not a “cure all” it is intended to save lives. And even one life saved is better than the alternative.

This technological application, when all or parts of the processes are employed, logistically brings together avatars such as students, employees, guests, law enforcement and first responders within the application to help track in real-time where the active shooter (or active perpetrator) is, where he or she has been, how many injuries have occurred, where they occurred, what injuries have been sustained, what are the medical history of those injured, and how said information is gathered, disseminated and procured by civil agencies.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a main screen;

FIG. 3 shows a sample of a setup screen;

FIG. 4 displays a sample location screen;

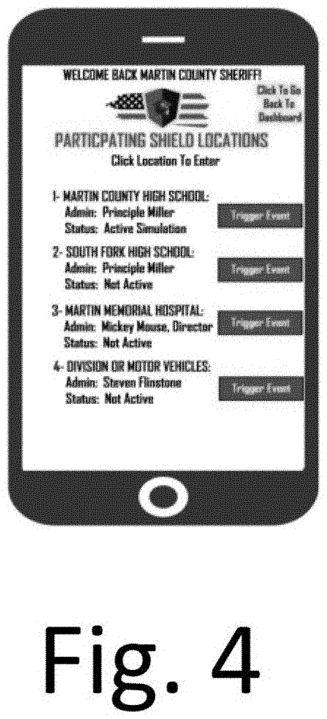

FIG. 5 displays a location setup flowchart; and

FIG. 6 shows a user setup flowchart.

### DESCRIPTION OF THE PREFERRED EMBODIMENT

There are a number of significant design features and improvements incorporated within the invention.

The current invention is a system 1 and application (app) that is geared towards limiting the damages of shooting incidents by creating technological processes that, when put in motion, create a real-time active shoot or incident “shield.” This invention provides a way for parties to obtain location specific real-time information at the place of such “incident” and to communicate this information in a very structured manner for those tasked with ending the active incident, preparing for and addressing the injuries and saving lives

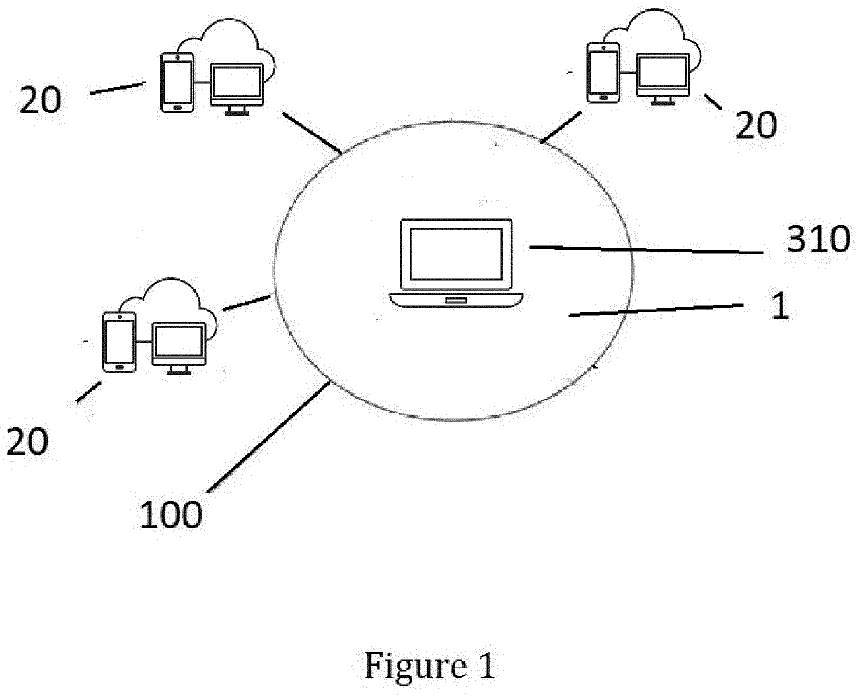

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device 20 with an appropriate amount of memory suitable for this purpose and an active connection to the Internet 500. Computing devices 20 like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 20 or smartphone communicating with others within the system 1.

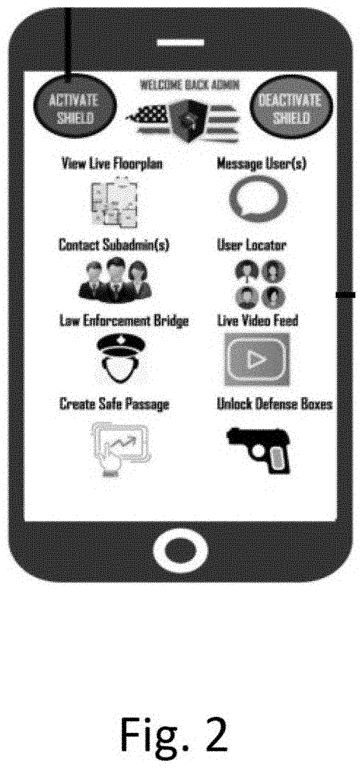

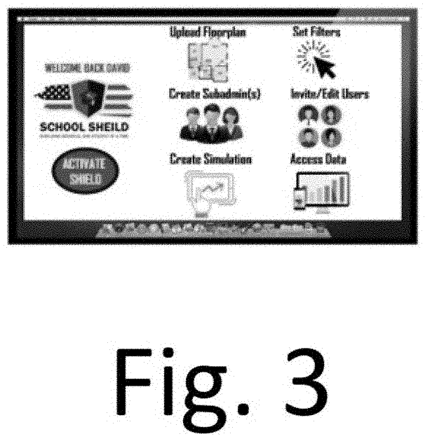

The system 1, data and processing code can reside in the non-transitory memory 310 of the one or more computing devices. The system 1 in the preferred embodiment would be written to act like a smart phone application (app). The system 1 will have a main screen as shown in FIG. 2 and a setup screen has shown in FIG. 3.

The system 1 works within a secure and centralized atmosphere. All actions, data collection, data requests and data transfers all occur within this closed matrix.

### BRIEF OVERVIEW

Law enforcement and first responders may access the “shield” platform via a computing device 20 such as a mobile device, tablets, or even a computer via a browser. The “shield” platform has a main user database 310 (or information storage unit) that collects and stores user data and actions aggregated from other databases that control the data between each avatar's actions and data. The Databases 310 will be operational for administration, users, law enforcement and first responders and parties to be named. Each user profile is unique, authenticated and data associated with each user action within the platform is stored logged within said databases. The “shield” platform is either assigned, downloaded, or pre-installed on mobile devices or tablets. Each user's device and subsequent account is then “programmed” with input based on user preferences such as demographics, desires, age, medical information, guardian information, emergency contacts and personal contact information. Administration, Law Enforcement and First Responder avatar's will also be able to access the invented platform and its associated data via desktop computer or device (i.e.: interactive tv, touch-board's that are enabled with a browser or third party app) or browser.

The “shield” platform can only activated by an authorized and authenticated administrator of a school or workplace or a place where a particular location was set up by a third party. The administrator can activate the “shield” platform when an incident arises or in a simulation mode. Once activated, the user avatar (i.e.: students, employees) device will activate, locking out other phone functions of said avatar. The “shield” platform regulates, stores and disseminates the information accumulated throughout the users any given moment of activity. The “shield” platform recognizes each unique user when the associated “shield” app client is activated by the user or it can be automatically activated when a user enters a specific location that is monitored by the “shield.”

The “Shooter Shield” is intended to help solve several major concerns that arise during and post any horrendous incident that could involve injuries and deaths such as a mass shooting in a school or in a workplace. There are three main avatars or users involved within the said platform invention. They include: administrators, users and outside user such as first responders and law enforcement.

This invented process, when put in motion with combined processes or in a standalone modes create and define numerous processes which is going to be needed to regulate the active shooter shield. The invented Platform regulates the activities and the data provided by the various users of the platform.

The three main users (“avatars”) involved with this invention are:

### 1) The Administrator

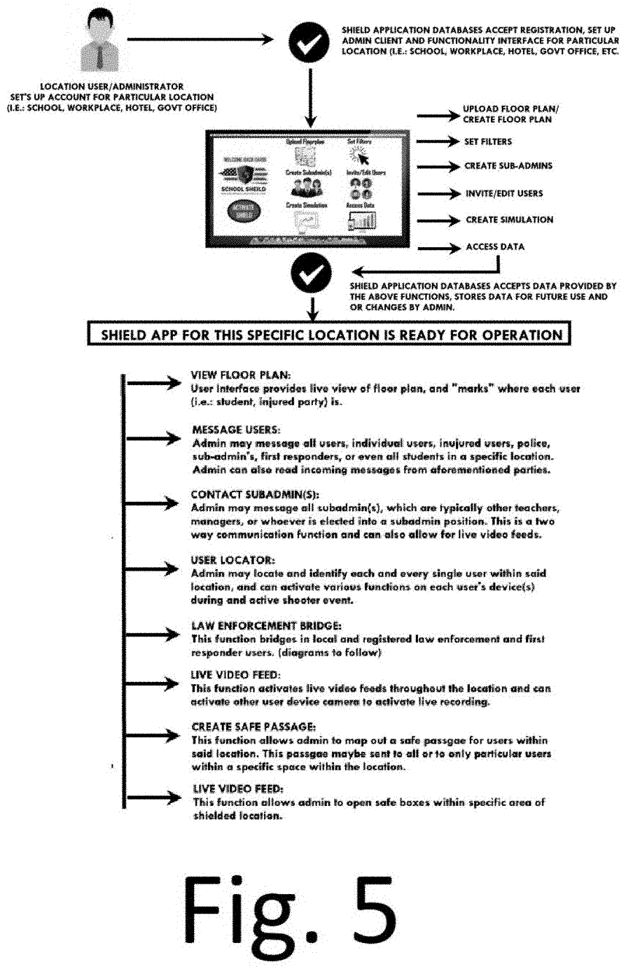

The administrator side of this invention is intended to create a platform hierarchy for each unique location as shown in FIG. 5, whether it be, for example, a school or a workplace. Through this hierarchy, administrators become authorized to “administer” the platform and to assure the users of the invented “shield” platform are registered and familiar with this invention.

The infrastructure allows for any workplace or school to set up administrator(s) who will be tasked with maintaining the platform. The administrator can then assign “tasks” or points of contacts within the workplace or school. For example, all classrooms could be assigned with “teacher” whose device is triggered during an incident, and would, for example, include features on their “user interface” to interact with that the students do not have. The invention is quite scalable and designed to instill the strictest possible structure imaginable.

Administrators will be able to upload or create their respective floor plans via a diverse set of tools built within the application. A few of the methods include: uploading and rendering the floor plans of said location; and/or creating video recording of the workspace that will make the invention “virtual” in nature.

Administrators also have the ability to control the platform users through a device 20 or computer interface, and to maintain a log of all the users' activity within the platform which is then aggregated in real-time and saved into the platform's databases for future use or by, for example, law enforcement and first responders.

Administrators will also have the ability to run the shield platform in a “test” mode, where an active shooter or terrorist scenario is “simulated” between all of the parties involved. The administrator can create the simulated scenarios. For example, using one shooter, or using multiple perpetrators within the administrator's location. The results of such scenarios are also saved for future use and to educate others on what or what not to do.

In summary, the administrator's role is to regulate the invented “shield” platform, the logistics between the data and participating avatar's, control what functions are used during an active incident, to disseminate said data between the parties and to train users within a simulated environment.

2) The Users

The user side of this invention is intended to eliminate the number of injuries and deaths associated with a horrendous crime by allowing users to keep track of the incident as it unfolds and to be able to communicate with administrators, law enforcement and first responders.

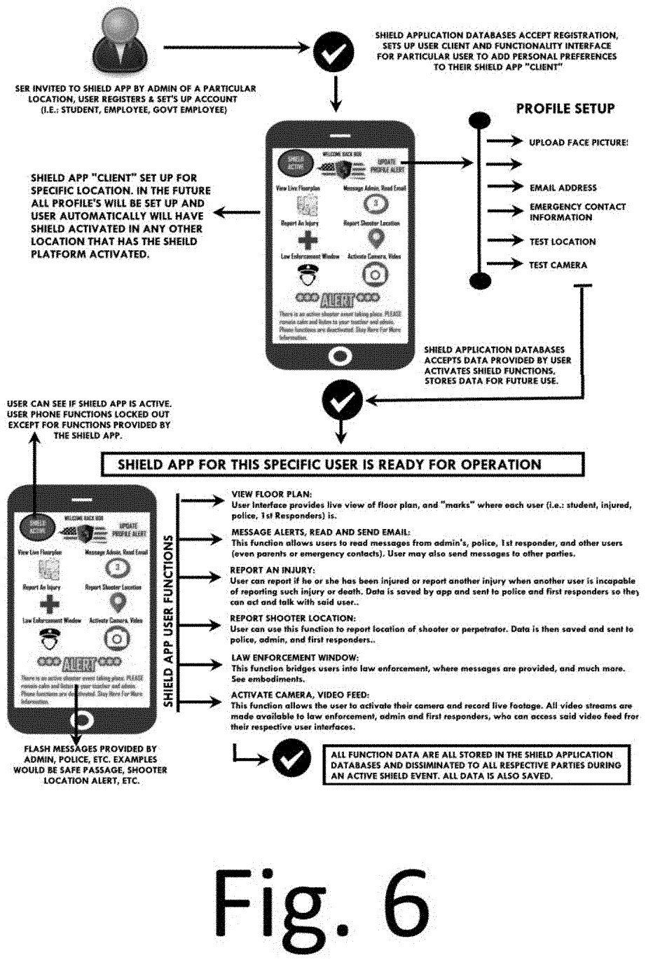

Said “Users” of this platform will typically be comprised of students, employees, shoppers and any third party that occupies a certain space that has been created by an administrator. These users are also able to access this invented platform via the desktop or mobile device during their initial registration and profile creation as shown in FIG. 6.

Users must register and verify their respective identities to be part of the platform. The administrator will provide a “secret” code that is generated in real-time for potential user to register. No code is the same, and codes are designated for each unique user. These code are then used by the platform to identify each user beyond their user profile information.

Once registered, users are able to create a user profile and be granted access to the “shield” platform to access his or her device information and grant permission(s) allowing the platform to access and to activate certain functions of the device such as the camera, texting, locator (GPS) and much more. These functions, while working in conjunction and with the invention's database and AI, are crucial to helping eliminate as many injuries and deaths as possible.

Users that are, for example, underage, would be registered and authenticated by a parent or a legal guardian in accordance with state, federal and laws initiated by governments around the world. User information gathered varies and is set by each unique administrator. User information can be comprised of, for example, age, height, weight, medical history (in compliance with H.I.P.P.A Laws), student or employee id #, and much more are all stored in the platform's databases.

When an active injury, death or hostage related event takes place, user devices will also be turned on automatically when an administrator, law enforcement, or any other authorized third party starts triggers the platform to engage. All user data is then correlated for relevancy and much more.

Once a user's device is activated, their location is immediately marked on the floor plan or virtual video overlay. This information is critical for law enforcement and first responders.

Users will be able to keep track of the incident as it unfolds. Users, for example, use their fingers to scroll or move though the workspace floor plan or virtual video layout and keep track of where the shooter or perpetrator is and can act accordingly. User can also send communications to both administrators and law enforcement.

Users can also report if they were injured, the extent of such injury, and receive medical advice from a first responder as to limit the damage associated with said injury.

### 3) Law Enforcement and First Responders

The law enforcement side of this invention is also plain and straight forward. The invented platform is intended to provide law enforcement and first responders with the most critical information and data in real-time as it pertains to the incident that is occurring in order to effectively diffuse the incident, keep track of the perpetrator and to access information on the injured.

Law Enforcement and first responders will navigate through the available schools or workplaces that are registered with the invented platform through the law enforcement database. To activate an active incident within their jurisdiction, they need only click on the location to access the user interface and available tools.

Law Enforcement and first responders will be able to receive information from users in real-time pertaining to the location of the perpetrator(s), description of the perpetrator(s), weapons being used, and any recordings that a user obtained during the incident. Law Enforcement and first responders will be able to view the floor plans to locate users. If, for example, a law enforcement official clicks on a specific classroom, that official will be able to do a “head-count” of the users located within that exact space and communicate with users or sub-administrator, such as a teacher, providing them with key details or updates in real-time.

Law Enforcement and first responders will be able to communicate directly with each user, especially an injured user, when necessary. A user, if injured, will activate an injury “beacon” within the app signaling they have been injured and where they are located. That beacon is seen and injury beacons are then aggregated by the invented platform. Once the beacon is activated, the user can then talk live with Law Enforcement and first responders or write a message pertaining to the extent of the injury.

Law Enforcement and first responders can, utilizing the data provided by the users, find the perpetrator(s), isolate the perpetrator(s) and take appropriate action to plan and stop the perpetrator(s) from causing any further damage or injuries.

Law Enforcement and first responders will be able to access all of the information that was produced during the incident for later investigative purposes or training.

### 4) Platform and Database Functionality Overview

The “shield” platform utilizes several databases that when working in tandem manage and produce the data sets from all active avatar's within the platform. The databases then correlates and disseminates information based on the said actions by each user and the personnel who manage the actual invented platform.

The “shield” platform regulates the information accumulated as a result of user input at any given moment of activity and is constantly sending this information back to the Shield Platform where it is organized and audited for real time information to those that need it.

The “shield” Platform processes must work together (OR STAND ALONE) to authenticate users, data, and data distribution to keep all parties informed in real-time as to what is occurring during the incident.

The “shield” platform recognizes and makes said data available to each user, the times of user activity, activity type, when activity data was entered or made available to other users.

The “shield” platform can instantly make data available on demand from one database to another, or multiple databases to another. For example, if a law enforcement is seeking data from the user database it can request it and said data will be disseminated accordingly.

The “shield” platform client interfaces and works with an active client, used by each partner to interact with the “shield” platform. Each avatar's client is programmed by each individual avatar which includes certain preferences, even a preferred language preferences.

The “shield” platform database auditing component/process of the “shield” platform audits and accumulates all the information activities from and between which each unique avatar's Client (user). For example, frequency of use, data accumulated, data exchanged with times and dates. The auditing component/process begins to audit each user when the user “logs” in or an administrator activates his or her unique “client” during an active event or simulation.

The auditing component/process audits information provided by each avatar's client and the “shield” platform. It audits the input information by a unique user and their client, audits the administer and law enforcement input and output, audits the demographics of each users “client” as well as the date, time and frequency of data input per “client”, audits the information regarding the users originated data, respective device function use, the amount of function use, audits the actual conversations, perpetrator path's, first responder and law enforcement conversations within the “shield” platform and much more.

The “Shield” Platform invention is essential and key for all active incidents as it provides “100%” true accurate data accumulated by all avatar devices and stores that data accordingly.

The “shield” platform allows for the real time auditing of a user's activity and platform history. The platform client, when active on a user's device, keeps track of the activity of the user and reports this information to the numerous database and components that drive this invention. The “shield” platform processes work together to authenticate users and data distribution. The “shield” platform is able to read and recognize and determine the user's type of device and can automatically trigger on (or off) certain the functions of said device such as its camera, light, Wi-Fi, and GPS functions to gather, record and disseminate real-time data during a mass shooting or “lock-down” incident.

The “shield” program can assign administrators for each school, workplace or location that utilizes the invented technology. The Administrators register and are granted certain permissions to use certain functions that other users are not able to use. Administrator will also create location profile (including misc. information about the school including fire alarm locations, emergency exits, etc.). Administrators will also create a user “profile” to include information about themselves, facial photo, emergency contact, medical background, and any other pertinent information that could be used by, for example, law enforcement and first responders.

The Administrators are able to upload the floor plans for a certain location which will be used by all parties into the “shield” platform. The Administrators are able to also video record the floor plan to provide a virtual reality type of floor plan which will be used by all parties within the “shield” platform. The administrator sets up the “shield” platform for each location through a mobile device or computer browser.

The administrator can designate “sub-administrators” who in turn can be used to manage certain spaces within said location that has been “shielded.” Sub-administrators would be responsible for reporting in information back to the Administrator regarding their respective said locations, including readiness and what is transpiring within said space. The administrator has the ability to verify registered users for each said location, delete users or restrict user functionality within the “shield” platform. The administrator can create and employ “simulated” active shooter or similar horrendous scenarios for training. As an example, administrator can create multiple scenarios using one shooter, or using multiple perpetrators, create a path which the simulated perpetrator takes as it relates to the location floor plans, designate non-admin users as injured parties within the simulation and much more. The results of such scenarios are also saved for future use and to educate others on what or what not to do.

The administrator can unlock or provide a confidential code to “sub-administrators” or a party selected by the administrator which could open a “weapons” safe within any space of the main location allowing sub-administrators to defend said space within the main location.

The administrator is able to communicate with all users one on one (via, for example, the live camera function or a “chat” function) during an incident including law enforcement and first responders. Examples of data provided to law enforcement and first responders would be: a) Name of and data of certain user who is believed to be the perpetrator; b) the location of said perpetrator; c) weapons being used or any other similar information.

In the preferred embodiment, the administrator is the only user who can delete user data. For example, if a student registers his or her device and activates the “shield” platform on their respective device, they will not be able to delete the information provided to the platform. This is a security measure to be sure all registered users data can be accessed in case one of the previously registered users has deleted the “shield” platform from their device 20.

The administrator or the platform will assign a unique ID for each user within said “shield” platform. Administrator may deactivate, delete and reassign new unique ids or the “shield” platform can do so automatically or on a fixed schedule. The Administrators can scroll (virtual walk-through) the floor plans and drop a pin on any area of said floor plan to identify, for example, the location of perpetrators. These pins will be correlated with the pins or known locations of the perpetrator reported by other, for example, students or employees within a particular workplace.

The Administrators are able to send “mass” messages to all non-administrator users within the location where the “shield” platform invention has been previously registered. Administrators can also send messages to certain audiences. Examples would be: message all users only located in a specific area of the floor plan and location; message all users who have reported themselves injured; or message all users located in a closed space (i.e.: closet, classroom, office) within said main location.

The Administrators can also contact all emergency contacts who were provided by a user during their initial registration and profile creation. Administrators can also receive (or block) incoming messages from said emergency contacts. The Administrators may grant access to all of the relevant data collected and stored by the “shield” platform to third parties such as law enforcement for investigative purposes post the incident.

The Administrators can create “SAFE ZONES” within the “shield” platform for users (i.e.: student's, employees) to go to. The Administrator will use data (i.e.: location of perpetrator) to create these said zones and alert all users (i.e.: students, employees) or only certain users within close proximity of said zone. The Administrator can (and can assign the same functionality to law enforcement and first responders) activate “live” feed permissions on Sub-Admin or other user devices as to provide a live feed back to the Administrator and law enforcement.

In order for a student, employee or other user of said “shield” platform, other than the administrator, to gain access to the “shield” platform, the Administrator will notify potential user candidates or provide them with a customized link or source to download the client associated with the “shield” platform. This is the gateway for each user to access said platform.

The student, employee or other person other than the administrator that registers for the platform will grant access to the “shield” platform to activate certain functions of each user's device such as: camera functions, GPS functions, messaging functions, and more. The student, employee or other person other than the administrator will create a unique profile consisting but not limited to the following: name, date of birth, email address, phone number, facial picture, medical history, emergency contact information, and other data sets to be determined.

The Administrator can change user profile data is necessary or request any of the avatar's to update their respective profiles. Administrator can also designate a new administrator if original administrator is injured or rendered incapable of handling the administrator duties as defined in this application.

The student, employee or other person other than the administrator will have their “shield” device activated by an administrator if and when an incident occurs. The administrator also controls the deactivation of the “shield” platform.

Once the “shield” platform and subsequent clients are activated, the administrator can lock out all other device functions within each user's device including the ability of an avatar to turn off their respective device while the “shield” platform and client are active.

Once activated the student, employee or other person other than the administrator's device will lock out other functions of the device. The student, employee or other person other than the administrator's device will instantly “map” and “track” each user's location according to their respective location within the said location for which the user is registered for.

Once the “shield” client is activated to interact with the “shield” platform on a student, employee or other person's device each user will be able to access the “shield” platform through a series of user interfaces with available functions. These functions include: alert the “shield” platform of any events taking place within a predetermined proximity to the user. In short, information during an incident will be rampant, but the “shield” platform is able to disseminate and make information more of a priority if need be. As an example prioritized information could be in the form of the known location of the perpetrator, area's where there are confirmed injuries and more.

Each user can alert the “shield” platform if they are injured and to what degree such injury is. Each user will also be able to take pictures or record video to show the degree of said injury. Each user can scroll through the floor plan to keep up track of said perpetrator and location of law enforcement or first responders. Each user can access a function which would allow them to contact their emergency contact, especially users who have been injured. This function can be made available as an open option for use, or the user can request the admin to allow to them communicate with an emergency contact. Emergency contacts may or may not be granted permission to contact user. The User will receive updates from administration and or law enforcement with incident updates, special instructions, and additional alerts based on perpetrator proximity in relation to each unique “shield” user. The User will be alerted as to safe zones created within the main location or safe location to the proximity of each user.

User can turn on live camera and video recorder to record or provide a live stream to the location they are at. Administrator can limit the amount of video feeds originating from locations where users are gathered. So if there are, for example, 12 students located in a classroom, the administrator can permit or limit any number of users to provide live feed video. Administrator can register local law enforcement and first responders in any locality. Administrator bundles “shield” platform localities for law enforcement and first responders in a bundle in accordance with jurisdictions. Law enforcement and first responders verify their acceptance of such access to the “shield” platform. Law enforcement and first responders are not limited roles, as roles could be filled by administrator. i.e.: Security personnel in an office building.

Law enforcement and first responders are alerted by the administrator when an active shooter or incident occurs. Likewise, the administrator can elect to delegate these responsibilities to numerous parties to trigger the “shield” platform.

Law enforcement and first responders will be able to pull up the floor plan of the active shooter incident. Law enforcement and first responders will be able to obtain real-time information from within the location of the active shooting via the data supplied by user client that interfaces with the “shield” platform. Law enforcement and first responders will be able to track the path of the criminal or perpetrator based on data provided by the users. Law enforcement and first responders can “scroll” through the location in real-time without entering the location to assess and determine the best way to end such incident.

Law enforcement and first responders can access chat logs between the administrator and users. Law enforcement and first responders can access live video from any one or multiple user devices.

Law enforcement and first responders can access head counts from each location based on user beacons. Law enforcement and first responders can switch location floor plans from a static floor plan to a pre-recorded “virtual” atmosphere. Law enforcement and first responders can communicate with all participating avatars via chat, phone call or a video chat. Law enforcement and first responders will be able to unlock doors, where applicable, and by pass security measure to gain access to the active shooter or incident location.

Law enforcement and first responders are able to trigger fire systems. i.e.: perpetrator starts a fire within a specific area within the location, the controls would be made available to put the fire out. Law enforcement and first responders can provide emergency escape routes to all users.

Law enforcement and first responders are able to be notified when an injury takes places when a user activates their injury beacon. Law enforcement and first responders can send group messages or messages to each unique users' device. Law enforcement and first responders can patch into their clients other law enforcement agencies. Law enforcement and first responders can patch in local hospitals or medical professionals to assist first responders. Law enforcement and first responders will be able to lock in the location of each injured party. Law enforcement and first responders will be able to communicate with the injured and pass along, for example, medical advice to try to stabilize said injury(s). Law enforcement and first responders will be able to access the medical background on all users who have a device client that interacts with the “shield” platform. Law enforcement and first responders based on the data provided by parties, can prepare medical attention for EACH injured party before they access the location of said incident.

Law enforcement and first responders can be directed into the location utilities and possess the ability to turn off the power in certain or all area's involved in the active incident.

Law enforcement and first responders are able to participate in all simulated incidents and training and have access to all of the data.

Law enforcement and first responders can act as “law enforcement and first responders” administrators, granting access to the “shield” platform to as many, for example, officers or first responders who are or who are not at the scene of the active shooter incident. i.e.: helicopter ambulances, etc. Law enforcement and first responders upon accessing the active shooter location, will alert users of their locations within said location so users know where they are.

Law enforcement and first responders can access, where applicable, the “pa” and “cctv” systems within the location of an incident. Law enforcement and first responders can contact user emergency contacts and likewise can send a mass message to all user emergency contacts pertaining to the incident, where to pick up users, etc. Law enforcement and first responders can receive messages from emergency contacts. Law enforcement and first responders can watch live real-time video from each “sub-administrators” device to see what is happening in any space (i.e.: classroom, office space) during the active shooter or incident. Law enforcement and first responders can also activate an injury beacon if they are injured and report the extent of such injury to first responders.

Law enforcement and first responders can provide live video feeds from their respective devices which has the “shield” platform client installed.

Law enforcement and first responders can designate an on scene supervisor to handle all of the logistics between the users, law enforcement and first responders. Law enforcement and first responder supervisors can limit functions on other devices (i.e.: users, law enforcement, first responders). Law enforcement and first responders can limit the amount of data derived by users that is disseminated to other law enforcement or first responders via the “shield” platform.

Law enforcement and first responders have the ability to alert all avatars if the incident is “over.” Once the incident has ended, either law enforcement or the administrator can turn off the active “shield” client and give control of user devices back to each respective user. Law enforcement and first responders will be able to “muster” users upon their exit from said location once the incident has been deemed “clear.”

Law enforcement and first responders will be able to access the data and download the data from the “shield” platform from each incident for investigative and training purposes. The data available for future use includes: user data, live video data, injury data, conversations between all avatars, time stamped events throughout the incident, and any and all data points referenced in this application.

The “shield” platform has what is known as a “super admin” and this super admin governs the entire “shield” platform. The Super admin controls various functions within the “shield” platform and user client's that interface with the “shield” platform.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system for reacting to an active shooter situation comprising;
having a system that resides in the non-transitory memory of a plurality of computing devices;
having the plurality of computing devices communicate on a closed network;
registering a plurality of locations;
identifying a shooting situation at a location;
identify the location of the shooter;
providing notification and communication of the shooting situation; and
providing information about the location.

2. A system according to claim 1 providing a blueprint of the location.

3. A system according to claim 1 allowing notification and location of injured.

4. A system according to claim 1 providing an interactive blueprint of the location.

5. A system according to claim 1 uniting a plurality of users.

6. A system according to claim 5 where the users are one or more from a set of first responders, law enforcement, parents, emergency contacts, and medical personal.

7. A system according to claim 5 having users being able to add third parties during an event.

8. A system according to claim 1 sending exit maps from a location.

9. A system according to claim 1 sending exit routes from a location.

10. A system according to claim 1 recording and storing the communication.

11. A system according to claim 1 sending allowing first responders to render first aid to injured parties via live communication; text and or live video,

12. A system according to claim 1 sending unique activation codes for authentication and placement.

13. A system for reacting to an active shooter situation comprising;
having a system that resides in the non-transitory memory of a plurality of computing devices;
having the plurality of computing devices communicate on a closed network;
uniting a plurality of users;
registering a plurality of locations;
identifying a shooting situation at a location;
identify the location of the shooter;
providing a blueprint of the location;
providing notification and communication of the shooting situation;
allowing notification and location of injured; and
providing information about the location.

14. A system according to claim 13 providing an interactive blueprint of the location.

15. A system according to claim 13 where the users are one or more from a set of first responders, law enforcement, parents, emergency contacts, and medical personal.

16. A system according to claim 15 having users being able to add third parties during an event.

17. A system according to claim 13 sending exit maps and routes from a location.

18. A system according to claim 13 recording and storing the communication.

19. A system according to claim 13 sending allowing first responders to render first aid to injured parties via live communication; text and or live video,

20. A system according to claim 13 sending unique activation codes for authentication and placement.
